(19) United States
(12) Patent Application Publication
(10) Pub. No.: US 2006/0197643 A1
(43) Pub. Date: Sep. 7, 2006

(54) Bobbin module of transformer

(75) Inventors: Ching-Fu Hsueh, Bade City (TW); Wen-Hsien Chen, Guansi Township (TW); Wan-Chin Hsu, Dasi Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Darfon Electronics Corp.

(21) Appl. No.: 11/365,180

(22) Filed: Mar. 1, 2006

(30) Foreign Application Priority Data
Mar. 1, 2005 (TW) 94106147

(51) Int. Cl. H01F 27/30

(52) U.S. Cl. 336/208

(57) ABSTRACT

A bobbin module of transformer is provided. The bobbin module includes two bobbins. Each of the bobbins comprises a body, an indentation and a hooker. The body has a lateral surface on which the indentation and the hooker are disposed. The hooker and the indentation of the bobbin are respectively engaged with the hooker and the indentation of the other bobbin so that the two bobbins are combined together.

This application claims the benefit of Taiwan application Ser. No. 94106147, filed Mar. 1, 2005, the subject matter of which is incorporated herein by reference.

### BACKGROUND OF THE INVENTION

1. Field of the Invention

The invention relates in general to a bobbin of transformer, and more particularly to a bobbin module of transformer capable of decreasing mold cost and increasing pressure resistance.

2. Description of the Related Art

With the popularity of multi-media products, the application of liquid crystal display (LCD) such as computer monitor and LCD TV is also becoming more and more popular. Typically, the LCD adopts slim and high efficient lamp tube driving system as the backlight, so that the thickness is reduced and that the display quality is improved. The lamp tube driving system of an LCD mainly consists of a cold cathode fluorescent lamp (CCFL) discharge lamp tube and a transformer used for driving the CCFL. Under the current trend of large-scaled LCD, the number of the lamp tubes is increased and the scale of the lamp tube enlarged. Consequently, the lamp tube driving voltage is increased. For example, the lamp tube driving voltage is increased from 1 KV to 3 KV and above, and the number of turns of the primary coils and the secondary coils are increased accordingly.

Conventionally, two bobbins are combined to provide more turns of the primary coils and the secondary coils. If two bobbins are combined to form a bobbin module, the combination must include one male bobbin and one female bobbin, and the two dimensional positioning for assembly can only be achieved in the x direction and the y direction. However, if the design of coupling one male bobbin with one female bobbin is adopted, two different molds are required to manufacture the male bobbin and the female bobbin respectively. Thus, the mold cost will be increased. Besides, when the bobbin module is hit by an external force, the two bobbins of the bobbin module may separate in the z direction.

Furthermore, after a conventional bobbin is wound in the primary coil and the secondary coil, the bobbin will form a transformer with an iron core. Then, the transformer is enclosed by the tape. However, the process of enclosing the bobbin, the coil and the iron core with the tape is very time-consuming and difficult, and the material cost for the tape is significant. Since the conventional transformer whose bobbin, coil and iron core are enclosed by the tape has a poor performance in pressure resistance, the conventional transformer is difficult to meet the requirements of the current trend of enlarging the scale of LCD panel and increasing the voltage of the lamp tube driving voltage.

### SUMMARY OF THE INVENTION

It is therefore an object of the invention to provide a bobbin module of transformer capable of decreasing mold cost and increasing pressure resistance. The invention forms two bobbins of identical structure by having the hooker and the indentation of a bobbin which are symmetric to each other be coupled together, not only making the assembly faster, but also achieving the positioning in x, y and z directions for assembly lest the separation of bobbin might occur when the conventional bobbin module receives an external force in the z direction. Besides, the invention requires only one set of mold. The manufacturer does not need to manufacture respective molds for the male bobbin mold and the female bobbin mold, largely decreasing the mold cost.

Furthermore, the invention achieves the object of fast positioning the bobbin and the base for assembly by using the design of engaging the fourth engaging blade of a bobbin with the first engaging blade of a base. The invention uses the second engaging blade and the third engaging blade to separate the two iron cores disposed in the first magnetic core receiving region and the second magnetic core receiving region from the coils of the primary coil and the secondary coil wound in the bobbin, substantially enhancing the pressure resistance of transformer and complying with the current trend in the design of enlarging the scale of the LCD panel and increasing the voltage of the lamp tube driving voltage.

The invention further achieves the above-identified object by providing a bobbin module of transformer. The bobbin module includes two bobbins. Each of the bobbins comprises a body, an indentation and a hooker. The body has a lateral surface. The indentation and the hooker are disposed on the lateral surface. The hooker and the indentation of a bobbin are respectively engaged with the hooker and the indentation of the other bobbin so that the two bobbins are combined together.

The invention further achieves the above-identified object by providing a bobbin module of transformer comprising a base and a bobbin. The base has a fillister. The bottom of the fillister has a first engaging blade, a second engaging blade and a third engaging blade parallel to the second engaging blade disposed thereon. The first engaging blade is perpendicular to and positioned between the second engaging blade and the third engaging blade. There is a first magnetic core receiving region existing between the second engaging blade and one wall of the fillister. There is a second magnetic core receiving region existing between the third engaging blade and the other wall of the fillister. The bobbin has a fourth engaging blade. Part of the fourth engaging blade is engaged with the first engaging blade, and part of the edge of the fourth engaging blade is abutted against the second engaging blade and the third engaging blade, so that the bobbin is fixed in the fillister in two mutually perpendicular directions.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A is an exploded diagram of a bobbin module of transformer according to a first embodiment of the invention;

FIG. 1B is top view of a bobbin of FIG. 1A;

FIG. 1C is a top view illustrating the state when the lateral surfaces of two bobbins of FIG. 1A viewed along the x direction form a contained angle;

FIG. 1D illustrates the assembly of two bobbin modules of FIG. 1C;

FIG. 2A is an exploded top view of a bobbin module of transformer according to a second embodiment of the invention;

FIG. 2B is top view of a base of FIG. 2A;

FIG. 2C is an upward view of the bobbin of FIG. 2A;

FIG. 2D is a top view of the bobbin of FIG. 2A;

FIG. 2E is a cross-sectional diagram of assembly of the bobbin module of transformer according to the second embodiment of the invention;

FIG. 2F is a top view of assembly of the bobbin module of transformer according to the second embodiment of the invention;

FIG. 3A is a part of cross-sectional exploded diagram of a bobbin module of transformer according toad third embodiment of the invention;

FIG. 3B is an upward view of a lift cover of FIG. 3A;

FIG. 3C illustrates the assembly of the lift cover of FIG. 3B and the bobbin of FIG. 2C; and

FIG. 3D is a cross-sectional assembly diagram of the bobbin module of transformer according to the third embodiment of the invention.

### DETAILED DESCRIPTION OF THE INVENTION

First Embodiment

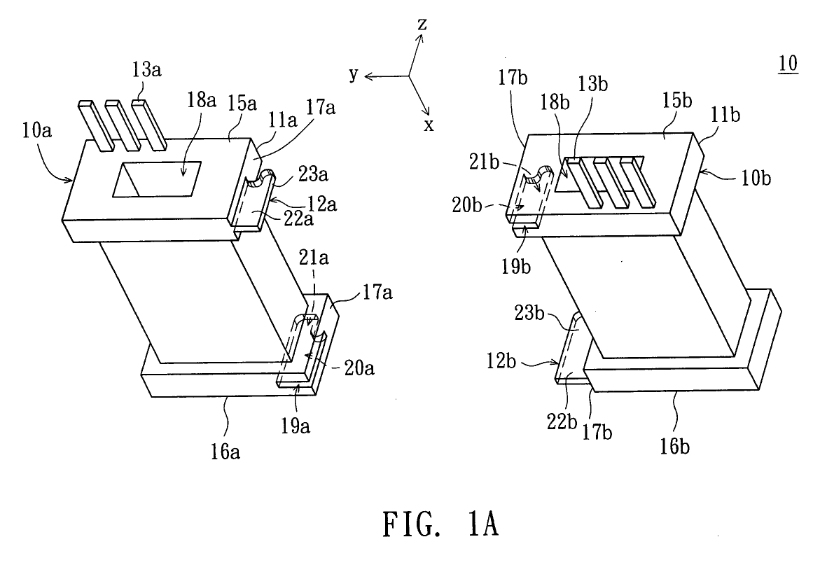

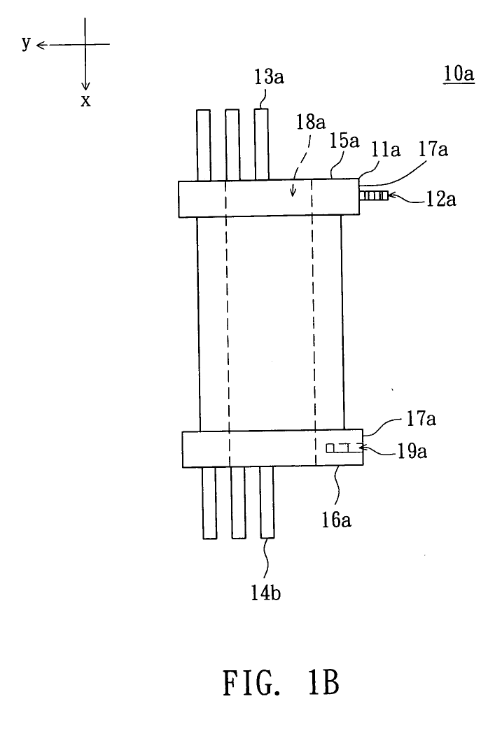

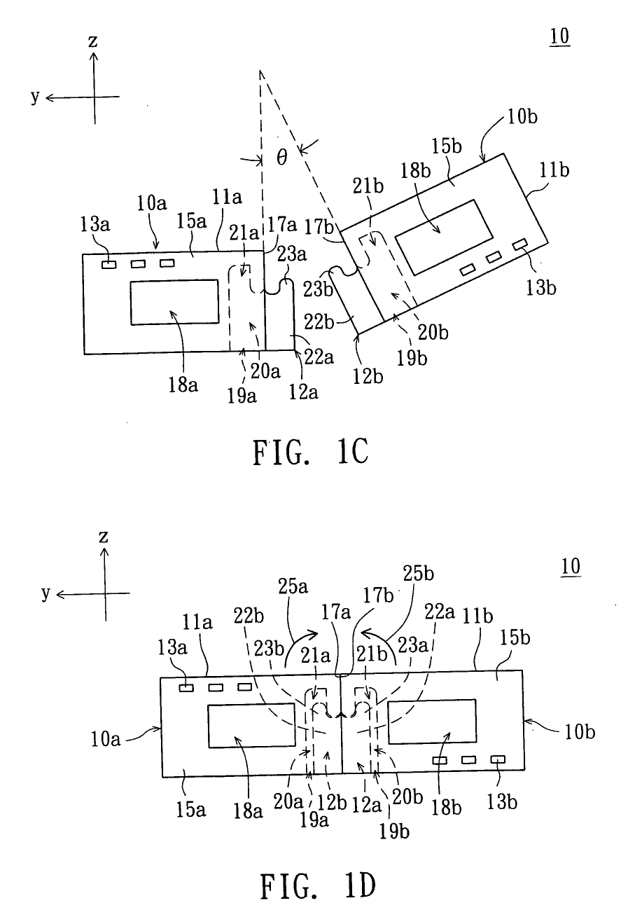

Referring to FIG. 1A, an exploded diagram of a bobbin module of transformer according to a first embodiment of the invention is illustrated. In FIG. 1A, the bobbin module of transformer 10 comprises two bobbins 10a and 10b. The bobbins 10a and 10b have the same structure and can be formed using the same bobbin mold. Thus, there is no need to manufacture respective molds for the male bobbin and the female bobbin, largely decreasing the mold cost. As shown in FIG. 1B, the bobbin 10a comprises a body 11a, a hooker 12a and an indentation 19a. The body 11a has a lateral surface 17a on which the hooker 12a and the indentation 19a are disposed. Similarly, the bobbin 10b comprises a body 11b, a hooker 12b and an indentation 19b. The body 11b has a lateral surface 17b on which the hooker 12b and the indentation 19b are disposed. When the bobbins 10a and 10b are combined together, the hooker 12a and the indentation 19a of the bobbin 10a are respectively engaged with the indentation 19b and the hooker 12b of the other bobbin 10b, so that the bobbin 10a and the bobbin 10b are combined together to form the bobbin module 10 by correspondingly coupling the hookers 12a and 12b with the indentations 19b and 19a.

Besides, the bobbin 10a further comprises at least a first pin 13a and at least a second pin 14a. The body 11a is wound by the primary coil and the secondary coil. The body 11a has a first surface 15a, a second surface 16a opposite to the first surface 15a, and a through hole 18a. The through hole 18a, which penetrates through the first surface 15a and the second surface 16a, is for a magnetic core to pass through. Examples of the magnetic core include an iron core. The lateral surface 17a connects with the first surface 15a and the second surface 16a. The indentation 19a is adjacent to the second surface 16a. The hooker 12a is adjacent to the first surface 15a. In the present embodiment of the invention, the indentation 19a has a gap 20a and a recess 21a accessible to each other. The hooker 12a comprises an elbow 22a and a protrusion 23a. One end of the elbow 22a is connected to the lateral surface 17a. The protrusion 23a is disposed on the other end of the elbow 22a, and is slightly protruded towards the lateral surface 17a. The first pin 13a and the second pin 14a are respectively disposed on the first surface 15a and the second surface 16a for enabling the primary coil and the secondary coil to be electrically connected to an external circuit. The body 11a and the hooker 12a can be integrally formed in one piece.

Similarly, since the bobbin 10b has the same structure with the bobbin 10a, as shown in FIG. 1A, the bobbin 10b further comprises a first pin 13b and at least a second pin. The body 11b is wound by the primary coil and the secondary coil. The body 11b further has a first surface 15b, a second surface 16b opposite to the first surface 15b, and a through hole 18b. The through hole 18b, which penetrates through the first surface 15b and the second surface 16b, is for a magnetic core to pass through. Examples of the magnetic core include an iron core. The lateral surface 17b connects with the first surface 15b and the second surface 16b. The indentation 19b is adjacent to the second surface 16b. The hooker 12b is adjacent to the first surface 15b. The body 11b and the hooker 12b can be integrally formed in one piece. In the present embodiment of the invention, the indentation 19b has a gap 20b and a recess 21b accessible to each other. The hooker 12b comprises an elbow 22b and a protrusion 23b. One end of the elbow 22b is connected to the lateral surface 17b. The protrusion 23b is disposed on the other end of the elbow 22b, and is slightly protruded towards the lateral surface 17b. The first pin 13b and the second pin are respectively disposed on the first surface 15b and the second surface 16b for enabling the primary coil and the secondary coil to be electrically connected to an external circuit. As shown in FIG. 1C, when the user is to combine the bobbin 10a and the bobbin 10b together, firstly, the user correspondingly inserts the hookers 12a and 12b into part of the indentations 19a and 19b by forming a contained angle θ between the lateral surfaces 17a and 17b. That is to say, the user correspondingly inserts part of the elbow 22a and the protrusion 23a into the gap 20b and part of the recess 21b, and correspondingly inserts part of the elbow 22b and the protrusion 23b into the gap 20a and part of the recess 21a.

Meanwhile, the bobbins 10a and 10b are at a preparatory assembly state. The contained angle θ ranges between 35˜45 degrees. Next, the user rotates the bobbins 10a and 10b which are at the preparatory assembly state to achieve a state that the lateral surface 17a and the lateral surface 17b are parallel to and face each other, so that the hookers 12a and 12b are correspondingly engaged with the indentations 19a and 19b as shown in FIG. 1D. The protrusions 23a and 23b are correspondingly coupled with the gaps 21b and 21a, and the elbows 22a and 22b are correspondingly inserted into the gaps 20b and 20a. In the present embodiment of the invention, the design of engaging the hookers 12a and 12b with the indentations 19a and 19b ascertains that the bobbin module 10 is positioned in x, y and z directions for assembly and avoids the separation of the bobbin in the z direction which may occur when the conventional bobbin module receives an external force.

When the user is to separate the bobbins 10a and 10b of FIG. 1D, firstly, the user rotates the bobbins 10a and 10b along the direction of the arrows 25a and 25b to form a contained angle θ between the lateral surface 17a and the lateral surface 17b, so that the hookers 12a and 12b are separated from the indentations 19a and 19b. Next, the user can easily separate the bobbin 10a from the bobbin 10b, hence achieving the object of making assembly and disassembly easy and fast.

The present embodiment of the invention forms two bobbins of identical structure by having the hooker and the indentation of a bobbin which are symmetric to each other be coupled together, not only making the assembly faster, but also achieving the positioning in x, y and z directions for assembly lest the separation of bobbin might occur when the conventional bobbin module receives an external force in the z direction. Besides, the invention only requires one set of mold. The manufacturer does not need to manufacture respective molds for the male bobbin and the female bobbin, largely decreasing the mold cost.

Second Embodiment

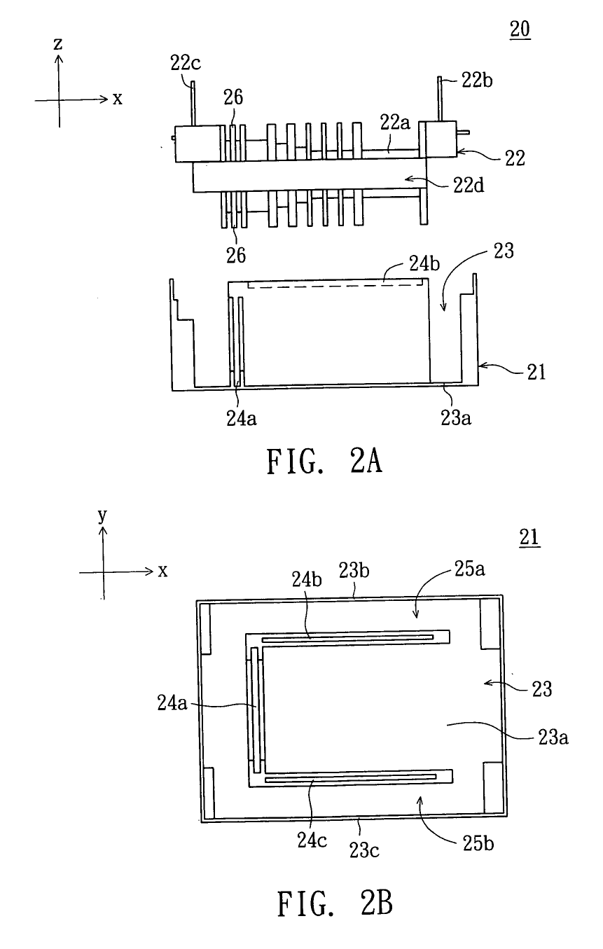

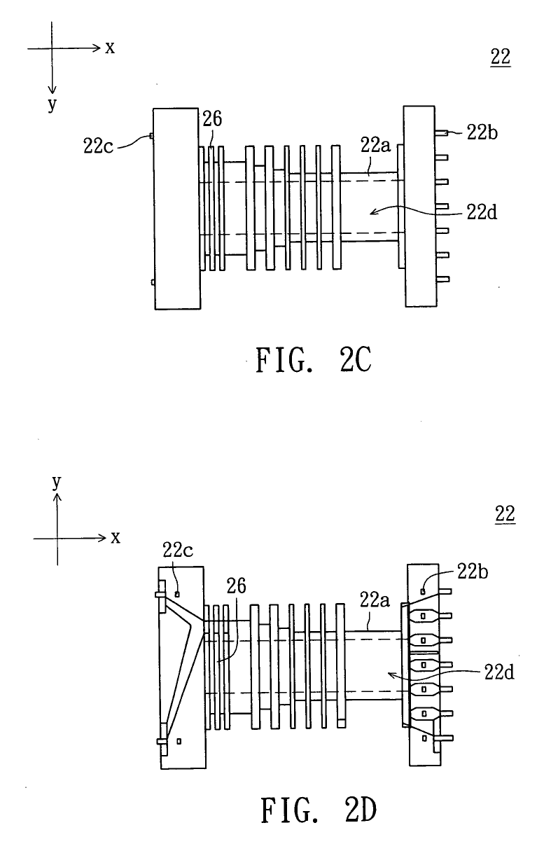

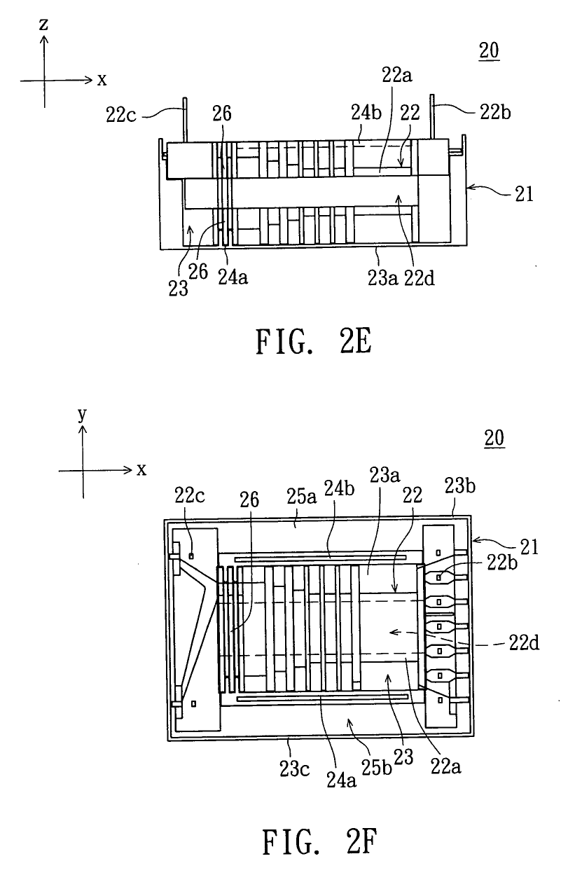

Please refer to FIGS. 2A˜2F at the same time. FIG. 2A is an exploded top view of a bobbin module of transformer according to a second embodiment of the invention. FIG. 2B is top view of a base of FIG. 2A. FIG. 2C is an upward view of the bobbin of FIG. 2A. FIG. 2D is a top view of the bobbin of FIG. 2A. FIG. 2E is a cross-sectional diagram of assembly of the bobbin module of transformer according to the second embodiment of the invention. FIG. 2F is a top view of assembly of the bobbin module of transformer according to the second embodiment of the invention. In FIG. 2A, the bobbin module of transformer 20 comprises a base 21 and a bobbin 22. The bobbin 22 is engaged with the base 21 to be disposed on the base 21 As shown in FIG. 2B, the base 21 has a fillister 23 whose bottom 23a has a first engaging blade 24a, a second engaging blade 24b parallel to the first engaging blade 24a, and a third engaging blade 24c disposed thereon. The first engaging blade 24a is perpendicular to and positioned between the second engaging blade 24b and the third engaging blade 24c. Besides, the first engaging blade 24a can connect with the second engaging blade 24b and the third engaging blade 24c. The height of the first engaging blade 24a can be lower than the height of the second engaging blade 24b and the height of the third engaging blade 24c. Furthermore, there is a first magnetic core receiving region 25a existing between the second engaging blade 24b and one wall of 23b of the fillister 23. There is a second magnetic core receiving region 25b existing between the third engaging blade 24c and the other wall of 23c of the fillister 23. The first magnetic core receiving region 25a and the second magnetic core receiving region 25b are respectively used for receiving a first magnetic core and a second magnetic core such as a first iron core or a second iron core.

As shown in FIGS. 2C˜2D, the bobbin 22 comprises a body 22a, a fourth engaging blade 26, a number of first pins 22b and a number of second pins 22c. The body 22a has a through hole 22d passing through the two ends of the body 22a. The through hole 22d is for the first iron core and the second iron core to plug into, so that the first iron core and the second iron core form a magnetic path in the bobbin module of transformer 10. The fourth engaging blade 26 winds itself round the body 22a to be disposed on the surface of the body 22a. Part of the fourth engaging blade 26 is engaged with the first engaging blade 24a. Part of the edge of the fourth engaging blade 26 is abutted against the second engaging blade 24b and the third engaging blade 24c. The other blades are wound on the surface of the body 22a for enabling the primary coil and the secondary coil to be wound round the body 22a. The first pin 13a and the second pin 14a are respectively disposed on the two lateral sides of the body 22a for enabling the primary coil and the secondary coil to be wound round the body 22a and electrically connected to an external circuit.

As shown in FIGS. 2E˜2F, when the bobbin 20 is disposed in the fillister 23 with the lower surface of the body 22a facing the bottom 23a of the fillister 23, part of the fourth engaging blade 26 positioned on the lower surface of the body 22a is engaged with the first engaging blade 24a. Part of the edge of the fourth engaging blade 26 is abutted against the second engaging blade 24b and the third engaging blade 24c, so that the bobbin 22 is fixed in the fillister 23 in two mutually perpendicular directions such as the x direction and the y direction of FIG. 2F.

The present embodiment of the invention achieves the object of fast positioning the bobbin 22 and the base 21 for assembly by using the design of engaging the fourth engaging blade 26 of the bobbin 22 with the first engaging blade 24a of the base 21. Besides, the present embodiment of the invention uses the second engaging blade 24b and the third engaging blade 24c to separate the two iron cores disposed in the first magnetic core receiving region 25a and the second magnetic core receiving region 25b from the primary coil and the secondary coil wound in the bobbin 22, substantially enhancing the pressure resistance of transformer and complying with the current trend in the design of enlarging the scale of the liquid crystal display (LCD) panel and increasing the voltage of the lamp tube driving voltage.

Any one who is skilled in the technology of the invention will understand that the technology of the present embodiment of the invention is not limited thereto. For example, the first engaging blade 24a, the second engaging blade 24b, the third engaging blade 24c, the bottom 23a, walls 23b and 23c can be integrally formed in one piece. The body 22a, the fourth engaging blade 26, and the other blades on the body 22a can be integrally formed in one piece. Besides, the first engaging blade 24a and the fourth engaging blade 26 corresponding to the first engaging blade 24a can be two E-shaped structures. Furthermore, the bobbin module of transformer 20 further comprises a colloid used for filling up the fillister 23a and covering up the bobbin 22, the first iron core, the second iron core, the primary coil and the secondary coil. Thus, the tape cost as well as the complicated process and labor of enclosing the bobbin, the coil and the iron core are saved.

Third Embodiment

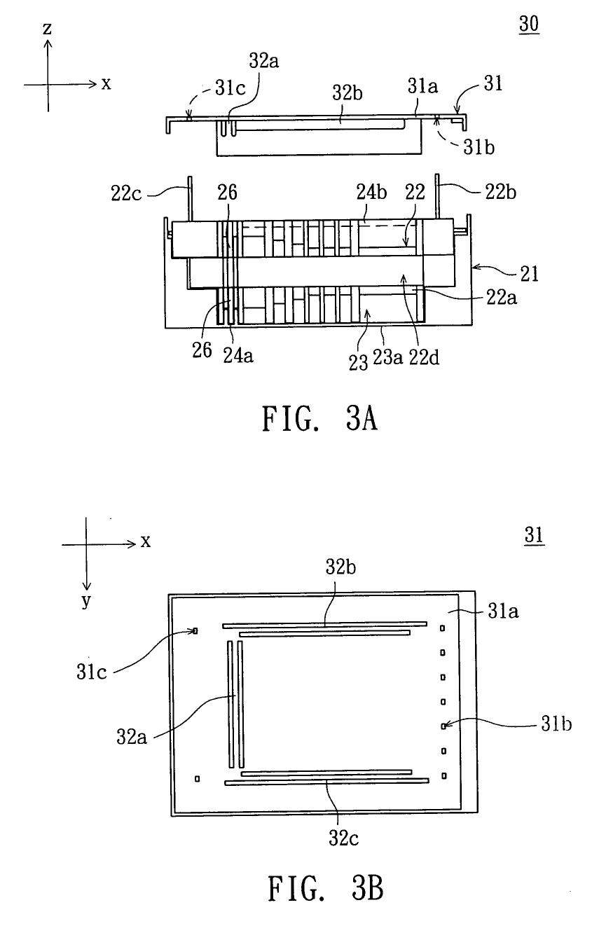

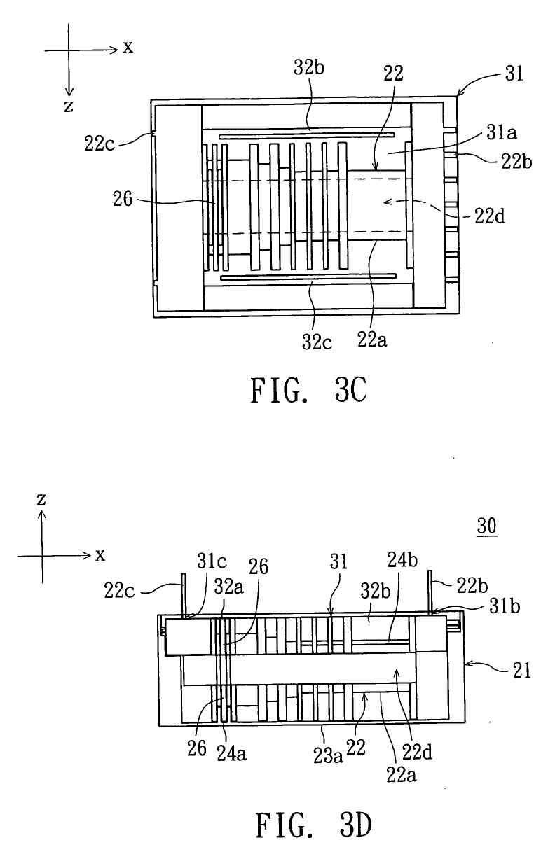

Please refer to FIGS. 3A˜3D. FIG. 3A is a part of cross-sectional exploded diagram of a bobbin module of transformer according toad third embodiment of the invention. FIG. 3B is an upward view of a lift cover of FIG. 3A. FIG. 3C illustrates the assembly of the lift cover of FIG. 3B and the bobbin of FIG. 2C. FIG. 3D is a cross-sectional assembly diagram of the bobbin module of transformer according to the third embodiment of the invention. The bobbin module of transformer 30 of the present embodiment of the invention differs with the bobbin module of transformer 20 of the second embodiment in having a lift cover 31. As for other similar components, the same reference numbers are used and are not repeated here. In FIGS. 3A˜3B, the lift cover 31 comprises a body 31a, a fifth engaging blade 32a, a sixth engaging blade 32b and a seventh engaging blade 32c parallel to the sixth engaging blade 32b. The body 31a has a number of openings 31b and 31c. The fifth engaging blade 32a, the sixth engaging blade 32b and the seventh engaging blade 32c are all disposed on the lower surface of the body 31a. The fifth engaging blade 32a is perpendicular to and positioned between the sixth engaging blade 32b and the seventh engaging blade 32c. The fifth engaging blade 32a, the sixth engaging blade 32b and the seventh engaging blade 32c are respectively engaged with the fourth engaging blade 26, the second engaging blade 24b and the third engaging blade 24c of FIG. 2F.

As shown in FIGS. 3C˜3D, when the lift cover 31 is coupled with the base 21 at least having a bobbin 22, a first iron core, a second iron core, a primary coil and a secondary coil, the fifth engaging blade 32a, the sixth engaging blade 32b and the seventh engaging blade 32c of the lift cover 31 are respectively engaged with the fourth engaging blade 26 positioned on part of the surface of the body 22a, the second engaging blade 24b and the third engaging blade 24c disposed on the base 21 as shown in FIG. 2F, so that the lift cover 31 is coupled with the base 21 and covers the bobbin 22 from atop. Besides, the first pin 22b and the second pin 22c respectively pass through the openings 31b and 31c of the lift cover 31 to be exposed outside the lift cover 31 and electrically connected to an external circuit. Before the lift cover 31 is coupled with the base 21, if the colloid fills up the fillister 23a and covers the bobbin 22, the first iron core, the second iron core, primary coil and secondary coil, then the lift cover 31 will be coupled with the base 21 and cover up the bobbin 22 and the colloid. Thus, the design of covering up the bobbin 22 through coupling the base 21 with the lift cover 31 enhances the pressure resistance of the transformer. If the manufacturing process of filling the colloid is introduced, the pressure resistance of the transformer will be greatly enhanced.

Any one who is skilled in the technology of the present embodiment of the invention will understand that the technology of the invention is not limited thereto. For example, the body 31a, the fifth engaging blade 32a, the sixth engaging blade 32b and the seventh engaging blade 32c are integrally formed in one piece.

The bobbin module of transformer disclosed in above embodiments of the invention, has the following advantages:

1. The invention forms two bobbins of identical structure by having the hooker and the indentation of a bobbin which are symmetric to each other be coupled together, not only making the assembly faster, but also achieving the positioning in x, y and z directions for assembly lest the separation of bobbin might occur when the bobbin module receives an external force in the z direction. Besides, the invention only requires one set of mold. The manufacturer does not need to manufacture respective molds for the male bobbin and the female bobbin, largely decreasing the mold cost.

2. The invention achieves the object of fast positioning the bobbin and the base for assembly by using the design of engaging the fourth engaging blade of a bobbin with the first engaging blade of a base.

3. The invention uses the second engaging blade and the third engaging blade to separate the two iron cores disposed in the first magnetic core receiving region and the second magnetic core receiving region from the primary coil and the secondary coil wound in the bobbin, substantially enhancing the pressure resistance of transformer and complying with the current trend in the design of enlarging the scale of the LCD panel and increasing the voltage of the lamp tube driving voltage.

4. The invention uses the colloid to fill up the fillister and cover up the bobbin, the first iron core, the second iron core, primary coil and secondary coil, not only saving considerable tape cost, but also saving the complicated process and labor of using the tape to enclose the bobbin, the coil and the iron core.

5. The invention encloses the bobbin through coupling the base with the lift cover, substantially enhancing the pressure resistance of the transformer. If the manufacturing process of filling the colloid is introduced, the pressure resistance of the transformer will be greatly enhanced.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A bobbin module of transformer comprising two bobbins, wherein each bobbin comprising:
a body having a lateral surface; and
a hooker and an indentation disposed on the lateral surface;
wherein the hooker and the indentation of the bobbin are respectively engaged with the indentation and the hooker of the other bobbin so that the two bobbins are combined together.

2. The bobbin module of transformer according to claim 1, wherein the two hookers are correspondingly inserted into part of the two indentations by forming a contained angle between the two lateral surfaces, and the two bobbins are at a preparatory assembly state;
wherein the two bobbins at the preparatory assembly state can be rotated to achieve a state that the two lateral surfaces are parallel to and face each other, so that the two hookers are correspondingly engaged with the two indentations.

3. The bobbin module of transformer according to claim 2, wherein the contained angle ranges between 35˜45 degrees.

4. The bobbin module of transformer according to claim 2, wherein each of the two indentations has a gap and a recess accessible to each other, and each of the two hookers comprises:
an elbow whose one end is connected to the lateral surface; and
a protrusion disposed on the other end of the elbow and protruded towards the lateral surface;
wherein when the contained angle is formed between the two lateral surfaces, part of the two elbows and the two protrusions are correspondingly inserted into the two gaps and part of the two recesses;
wherein when the two lateral surfaces are parallel to and face each other, the two protrusions are correspondingly coupled with the two gaps, and the two elbows are correspondingly inserted into the two gaps.

5. The bobbin module of transformer according to claim 1, wherein the two bobbins can be formed by using the same bobbin mold.

6. The bobbin module of transformer according to claim 1, wherein the body further has a through hole penetrating through a first surface and a second surface of the bobbin module.

7. The bobbin module of transformer according to claim 1, wherein each of the two bobbins further comprises:
a first pin disposed on a first surface of the bobbin module.

8. The bobbin module of transformer according to claim 7, wherein each of the two bobbins further comprises:
a second pin disposed on a second surface of the bobbin module.

9. A bobbin module of transformer, comprising:
a base having a fillister whose bottom has a first engaging blade, a second engaging blade and a third engaging blade parallel to the second engaging blade disposed thereon, wherein the first engaging blade is perpendicular to and positioned between the second engaging blade and the third engaging blade, there is a first magnetic core receiving region existing between the second engaging blade and one wall of the fillister, and there is a second magnetic core receiving region existing between the third engaging blade and the other wall of the fillister; and
a bobbin having a fourth engaging blade, wherein part of the fourth engaging blade is engaged with the first engaging blade, and part of the edge of the fourth engaging blade is abutted against the second engaging blade and the third engaging blade, so that the bobbin is fixed in the fillister in two mutually perpendicular directions.

10. The bobbin module of transformer according to claim 9, wherein the first engaging blade connects with the second engaging blade and the third engaging blade.

11. The bobbin module of transformer according to claim 9, wherein the height of the first engaging blade is lower than the height of the second engaging blade and the height of the third engaging blade.

12. The bobbin module of transformer according to claim 9, further comprising:
a lift cover having a fifth engaging blade, a sixth engaging blade and a seventh engaging blade parallel to the sixth engaging blade, wherein the fifth engaging blade is perpendicular to and positioned between the sixth engaging blade and the seventh engaging blade, and the fifth engaging blade, the sixth engaging blade and the seventh engaging blade are respectively engaged with the fourth engaging blade, the second engaging blade and the third engaging blade, so that the lift cover covers up the bobbin.

13. The bobbin module of transformer according to claim 9, further comprises:
a colloid for filling up the fillister and covering up the bobbin.

14. The bobbin module of transformer according to claim 13, further comprises:
a lift cover having a fifth engaging blade, a sixth engaging blade and a seventh engaging blade parallel to the sixth engaging blade, wherein the fifth engaging blade is perpendicular to and positioned between the sixth engaging blade and the seventh engaging blade, and the fifth engaging blade, the sixth engaging blade and the seventh engaging blade are respectively engaged with the fourth engaging blade, the second engaging blade and the third engaging blade, so that the lift cover covers up the bobbin and the colloid.
